(19) United States
(12) Patent Application Publication
(10) Pub. No.: US 2026/0044992 A1
(43) Pub. Date: Feb. 12, 2026

(54) GENERATION OF BRAND-ALIGNED PRODUCT IMAGES

(71) Applicant: Adobe Inc., San Jose, CA (US)

(72) Inventors: Dhwanit AGARWAL, San Jose, CA (US); Umang MOORARKA, Bilaspur (IN); Shradha AGRAWAL, Milpitas, CA (US); Vangala Naveen REDDY, Hyderabad (IN); Ambareesh REVANUR, San Jose, CA (US)

(21) Appl. No.: 18/797,166

(22) Filed: Aug. 7, 2024

(51) Int. Cl. G06T 11/00; G06T 7/11

(52) U.S. Cl. CPC G06T 11/00; G06T 7/11; G06T 2211/441

(57) ABSTRACT

Methods, computer systems, computer storage media, and graphical user interfaces are provided for facilitating generation of brand-aligned product images. In one implementation, a product-environment prompt including a text description of a reference image is obtained. Further, a set of image features extracted from the reference image is obtained. Thereafter, a brand-aligned product image is generated by performing outpainting from a product representation in accordance with the product-environment prompt and the set of image features extracted from the reference image. The brand-aligned product image can then be provided for display via a graphical user interface.

### BACKGROUND

A rich repository of brand resources may exist for use in association with a brand (e.g., brand imaging). Such brand resources may encompass a wide array of assets, such as preapproved backgrounds, imagery, visuals from previous campaigns, and brand-specific color palettes. Oftentimes, brand resources are used to launch a new product and/or promote a product. For example, to generate a digital image to promote a product, an existing brand image may be used to draw inspiration for creating a new image for the brand product. To do so, a product representation is generally placed in a background setting similar to an existing brand image. However, drawing inspiration from a brand's existing imagery while maintaining the fidelity of the product or object in the foreground and adhering to the brand's design guidelines is difficult to accomplish.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating generation of brand-aligned product images. At a high level, to generate a brand-aligned product image, a reference image is generally used as a basis or source of inspiration for generating a background for a product that aligns with a brand corresponding with the product. Further, the reference image may be selected in accordance with a particular theme such that the generated brand-aligned product image is directed to a desired theme and, as such, may target a particular audience segment. In accordance with embodiments described herein, both a text-based description of a reference image and a set of image features visually describing the reference image may be used to generate the brand-aligned product image. In this way, various design aspects associated with the reference image are captured in the background generated for the brand-aligned product image. For example, the composition, scene, colors, and style of shot of the image are captured in the background of the brand-aligned product image as well as the lighting, textures, gradients, etc. Further, in accordance with embodiments described herein, the fidelity of the product representation in the brand-aligned product image is preserved such that the product is represented in a desired manner.

### BRIEF DESCRIPTION OF THE DRAWINGS

The technology described herein is described in detail below with reference to the attached drawing figures, wherein:

FIG. 1 is a block diagram of an exemplary system for generation of a brand-aligned product image, suitable for use in implementing aspects of the technology described herein;

FIG. 2 is an example implementation for facilitating generation of a brand-aligned product image, via a brand-aligned product image manager, in accordance with aspects of the technology described herein;

FIG. 3 provides an example process flow, in accordance with embodiments described herein;

FIGS. 4A-4D provide examples of various images associated with the brand-aligned product image generation process, in accordance with embodiments described herein;

FIG. 5 provides an example method for facilitating generation of brand-aligned product images, in accordance with embodiments described herein;

FIG. 6 provides another example method for generation of brand-aligned product images, in accordance with embodiments described herein;

FIG. 7 provides another example method for generation of brand-aligned product images, in accordance with embodiments described herein; and

FIG. 8 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

In today's business landscape, content is oftentimes created in association with a brand. For example, emails, portable document formats (PDFs), and websites can be created that incorporate a representation of a brand. A brand generally refers to a unique representation associated with an entity, such as a product, service, organization, or individual. Generally, effective branding includes creating a distinct identity that sets the entity apart from competitors, as well as building trust and loyalty among customers. As customers develop a relationship and trust in association with a brand, it is valuable for the brand to be consistently represented in content. In this way, consistent brand representation may ensure that individuals appropriately recognize and/or differentiate a brand.

Accordingly, a brand may correspond with a rich repository of brand resources, also referred to as a brand kit, for use in association with a brand (e.g., brand imaging). Such brand resources may encompass a wide array of assets, such as preapproved backgrounds, imagery, and visuals from previous campaigns, and brand-specific color palettes. Oftentimes, brand resources are used to launch a new product and/or promote a product. For example, to generate a digital image to promote a product, the existing brand imagery may be used to draw inspiration for creating a new image for the brand product. To do so, a product representation is generally placed in a background setting similar to an existing brand image. Not only does such an approach increase the likelihood of gaining quick approval for the new visual content, but it also aligns the new visual content with the brand identity, as reflected in the existing brand imagery.

In addition, generating imagery that is personalized or provides an engaging customer experience for a target audience is oftentimes desired. One approach for attaining customization includes selecting relevant images from a set of existing brand resources or assets to serve as inspirational references and incorporate such inspirations into images. For example, assume a brand desires a dirt road-themed campaign for a new SUV to appeal to a target audience who frequently engages in off-roading-style adventure activities. As such, an image may be desired that places the SUV on a dirt road with adventure-themed background that exists in the corresponding approved brand kit.

Generating personalized product images that adhere to brand guidelines, however, is complex. In particular, drawing inspiration from a brand's existing imagery while maintaining the fidelity of the product or object in the foreground and adhering to the brand's design guidelines is difficult to accomplish. Conventional implementations rely largely on various manual efforts, for example, collaboration between content creators and those enforcing brand guidelines (e.g., brand managers interpreting aspects of the brand guidelines to verify compliance of brand-representative content). To do so effectively, content creators, marketers, copywriters, and/or managers require a comprehensive understanding and interpretation of brand guidelines, making sure the content created embodies the brand's unique identity, voice, and messaging. However, this approach is not only time-consuming and labor-intensive, but also suffers from inconsistency due to the inherent subjectivity of individuals' interpretations of the guidelines. Accordingly, such a manual approach is labor-intensive, error-prone, and fails to capture the intricacies of distinct guidelines.

There have been attempts to generate product images using artificial intelligence. For example, one approach includes using artificial intelligence (AI) for placing a product within an appropriate background setting. For example, a prompt may be generated that attempts to place a brand product in a background setting inspired from existing brand imagery. In addition to the challenges related to generating an effective prompt, current text-based AI models limit the user to describing all desired attributes using text. However, various imagery aspects, such as brand styles and design philosophy, are often visual and difficult to convey via text. For example, using text to describe a specific type of photography style, a color gradient, a color palette, a tone of a specific color, etc., is oftentimes difficult and inaccurate. Further, a background setting in an image may also be difficult to describe in text. For instance, assume a beach near a mountain range is desired. In such a desired image, various aspects may contribute to the ambiance of an image, but may not be easily describable using text, such as, for example, the texture of sand on a beach, distant silhouettes of individuals, the faint outline of mountains on the horizon, etc. As a result, such approaches often do not align with the particular background composition, lighting concepts, and/or the like of the source of inspiration.

Moreover, unnecessary computing resources are utilized in generating product images using conventional approaches. For example, computing and network resources are unnecessarily consumed to facilitate the labor-intensive process in reviewing and revising both manually generated and automatically generated product images. For instance, computer input/output operations are unnecessarily increased in manually creating product images to ensure the generated content complies with brand guidelines. Automated solutions similarly lack the ability to ensure that the generated product images comport with brand guidelines and include a desired background. For example, using only a user-provided text description of a desired background can result in a generated product image that is void of many desired image aspects (e.g., that may be difficult to describe in text or that may be overlooked). As such, computer input/output operations are unnecessarily increased in the process of creating additional product images in an automated manner in an effort to attain a desired background for a product. In this way, computing and network resources are consumed to generate product images and, in cases in which the resulting product images are undesired, the computing and network resources are again consumed to generate a new product image.

Accordingly, embodiments described herein are directed to facilitating generation of brand-aligned product images. In this way, product images that align with a brand are generated in an automated manner. As described herein, a product image refers to an image that includes a product representation positioned or placed among a background setting or environment. In a brand-aligned product image, such a background setting or environment aligns with a brand (e.g., brand guidelines or preferences). In this way, embodiments herein provide a seamless one-step approach to generate customized product imagery that adheres to brand identity.

At a high level, to generate a brand-aligned product image, a reference image is generally used as a basis or source of inspiration for generating a background for a product that aligns with a brand corresponding with the product. Further, the reference image may be selected in accordance with a particular theme such that the generated brand-aligned product image is directed to a desired theme and, as such, may target a particular audience segment. In accordance with embodiments described herein, both a text-based description of a reference image and a set of image features visually describing the reference image may be used to generate the brand-aligned product image. In this way, various design aspects associated with the reference image are captured in the background generated for the brand-aligned product image. For example, the composition, scene, colors, and style of shot of the image are captured in the background of the brand-aligned product image, as well as the lighting, textures, gradients, etc. Further, in accordance with embodiments described herein, the fidelity of the product representation in the brand-aligned product image is preserved such that the product is represented in a desired manner.

In operation, in one example, a product representation (e.g., via an image) and a product theme are obtained. The product representation and/or the product theme may be selected or input by a user desiring to generate or view a brand-aligned product image. Based on the product theme, a set of candidate reference images may be identified for possible background inspirations for generating a brand-aligned product image. In one approach, a vector database containing embeddings associated with various brand-approved images may be searched to identify the set of candidate reference images that match or correspond with the desired product theme. A particular reference image may be selected, for example, from among the set of candidate reference images that match a desired product theme, for use as inspiration in generating a background for a brand-aligned product image.

In accordance with obtaining or identifying a reference image, a text description may be generated to describe the reference image. In this way, a product-environment prompt may be generated that textually describes various components of the image, such as composition, scene, colors, and/or style of shot. In some cases, to generate text descriptions associated with various image components, the reference image may be input into a large multimodal model along with an instruction to describe the image in association with one or more image components (e.g., composition, scene, colors, style of shot, etc.). The text descriptions associated with the different image components may then be combined or aggregated into a product-environment prompt for use in generating a brand-aligned product image.

To generate a brand-aligned product image, an image-augmented outpainter facilitates such image generation by performing outpainting in association with a product representation. In this regard, the image-augmented outpainter obtains the product representation and the product-environment prompt that textually describes the reference image and performs outpainting in association therewith to generate a background that is inspired by the reference image. In embodiments, in addition to using the product-environment prompt to perform outpainting in association with the product representation, image features are also used. As such, the image-augmented outpainter may extract image features from the input reference image and, thereafter, utilize the extracted image features to generate an outpainted image that includes a background environment corresponding with, or similar to, the background of the reference image. Upon generating the outpainted image, the image may be refined and/or artifacts removed to, among other things, preserve fidelity of the product representation in the outpainted image. The resulting brand-aligned product image may be presented to the user. In some embodiments, feedback may be provided (e.g., by a user) in association with the presented brand-aligned product image. Such feedback may be provided in any number of ways, for example, to reflect approval of the brand-aligned product image or disapproval of the brand-aligned product image. The feedback may be used to adjust the brand-aligned product image accordingly. In this way, various iterations of feedback may be applied to generate a brand-aligned product image that corresponds with desires and preferences of a user, while maintaining the product representation fidelity and ensuring brand consistency.

Advantageously, using a brand-approved reference image to perform outpainting in association with a product representation ensures the background created for the product representation aligns with the brand corresponding with the product. Further, using a text-based description (e.g., via a product-environment prompt) of a reference image and image features extracted from the reference image to generate a brand-aligned product image enables a more holistic and accurate reflection of the reference image, thereby improving the generation of a background for the product representation. Generating a brand-aligned product image that conforms to or aligns with a brand for a product reduces computing resource utilization. For example, automatically generating a brand-aligned product image that corresponds with a desired reference image and preserves fidelity of the product representation in the image reduces computing resource utilization that would otherwise be needed to iteratively generate images to reflect a desired background and/or to appropriately adjust the product represented in the image. As another example, computing resource utilization may be reduced that would otherwise be needed to analyze whether a generated image containing a product accurately reflects a brand (e.g., brand guidelines).

Although various examples described herein refer to a product representation, the technology described herein may refer to other objects that may be presented within a background environment. In this regard, any foreground object may be used in accordance with embodiments described herein.

Various terms are used throughout the description of embodiments provided herein. A brief overview of such terms and phrases is provided here for ease of understanding, but more details of these terms and phrases are provided throughout.

A brand generally refers to a unique representation associated with an entity, such as a product, service, organization, or individual.

A brand guideline generally refers to a rule or instruction that indicates how a brand should be represented, for example, visually and/or verbally. In this regard, brand guidelines are intended to ensure consistency in a brand's identity, messaging, and/or visual elements, regardless of where and how these components are displayed across various media channels.

A brand-aligned product image generally refers to a product image that includes a background environment or setting that aligns with a brand associated with the product. A product image generally refers to an image including a representation of a product. Generally, the representation of the product is in the foreground of the image with a background environment or setting.

A product representation, or representation of a product, refers to an image or visual depiction of a product that focuses on the product. In this way, a product representation does not include background details. In some cases, a product representation may be isolated or “cut-out,” such that the product representation is confined within the boundaries or edges of the product.

A product-environment prompt generally refers to a prompt that includes a text description of a background or environment desired for a product. In this regard, the product-environment prompt may textually describe various aspects of a reference image that is to be used as a basis or source for performing outpainting in association with a product.

A reference image refers to an image having a background or environment setting that is desired as a source or inspiration for performing outpainting in association with a product. In some cases, a reference image is approved or preconfigured in association with a particular brand that corresponds with a product.

Outpainting generally refers to image outpainting or image extrapolation in which an existing image is extended beyond its original boundaries. In this regard, outpainting includes generating new content that seamlessly blends with the original image, such as a product representation, thereby effectively expanding the visual scene. Outpainting may be performed using various technologies, such as generative adversarial networks (GANs) or diffusion models, which are trained to understand patterns and structures within the image and generate coherent extensions. In embodiments, the outpainting takes into account a reference image, such as a text description of the background of the reference image and/or a set of features extracted from the reference image, such that the resulting outpainted image includes a background similar to the reference image.

### Overview of Exemplary Environments for Facilitating Generation of Brand-Aligned Product Images

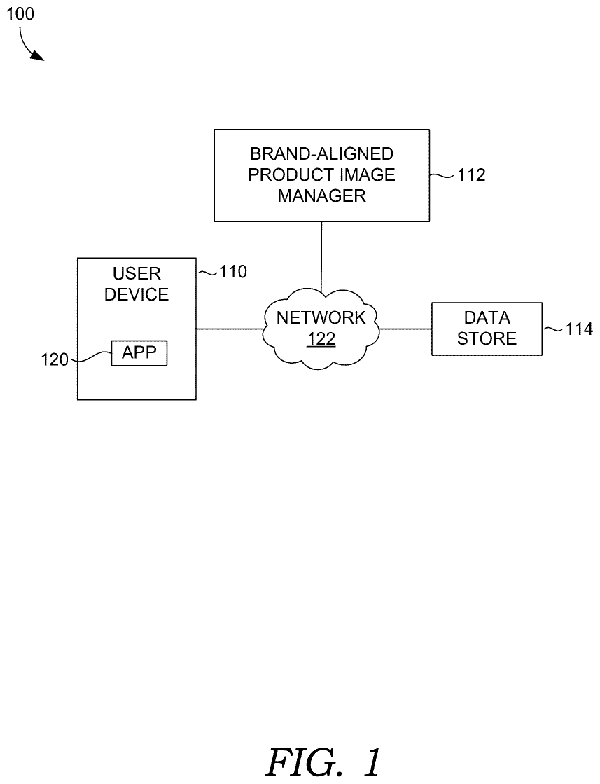

Referring initially to FIG. 1, a block diagram of an exemplary network environment 100 suitable for use in implementing embodiments described herein is shown. Generally, the system 100 illustrates an environment suitable for facilitating generation of brand-aligned product images. Among other things, embodiments described herein effectively and efficiently generate brand-aligned product images based on a reference image, while maintaining brand alignment and preserving product details.

In operation, a user, such as a marketer, can input or provide a product representation (e.g., in the form of an image, or portion thereof) and a target theme(s) and, based on the input, be automatically provided with one or more brand-aligned product images. A product representation generally refers to a representation of a product, which may be in the form of an image or a portion thereof. A target theme generally refers to a desired theme to be captured in the background portion of the brand-aligned product image. A brand-aligned product image generally refers to a product image that aligns with a particular brand, such as a set of brand guidelines. In this way, various aspects associated with brand guidelines are represented or reflected in the brand-aligned product image. Generally, the brand-aligned product image is generated in a manner intended to convey representation of a brand. A product image generally includes the product in the foreground of the image. In this way, the product image generally includes a background and a product representation in the foreground.

The network environment 100 includes a user device 110, a brand-aligned product image manager 112, and a data store 114. The user device 110, the brand-aligned product image manager 112, and the data store 114, can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device may be in communication with the brand-aligned product image manager 112 via a mobile network or the Internet, and the brand-aligned product image manager 112 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the brand-aligned product image manager 112 and/or data store 114 may be integrated with the user device 110. For instance, a portion of the brand-aligned product image manager 112 may be integrated with a server in communication with a user device 110, while another portion of the brand-aligned product image manager 112 may be integrated with the user device 110.

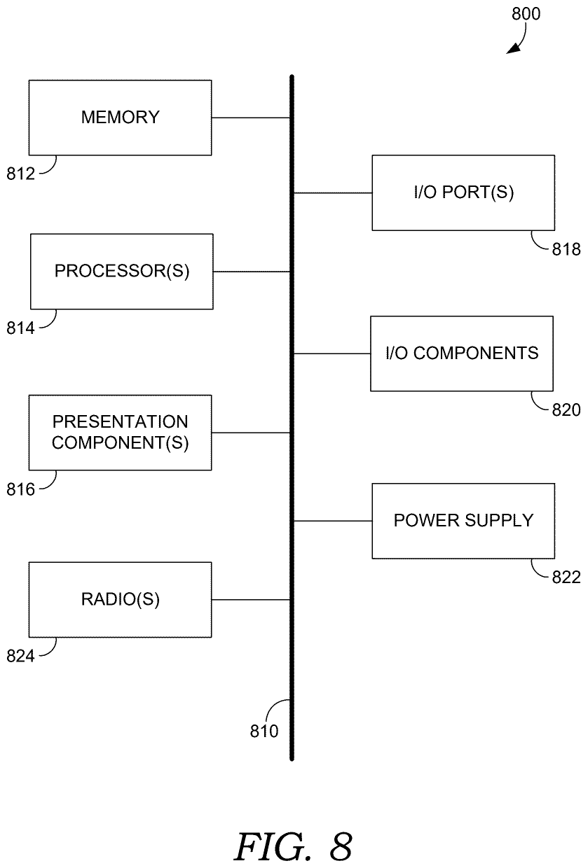

The user device 110 can be any kind of computing device capable of facilitating efficient and effective generation of brand-aligned product images. For example, in an embodiment, the user device 110 can be a computing device such as computing device 800, as described above with reference to FIG. 8. In embodiments, the user device 110 can be a personal computer (PC), a laptop computer, a workstation, a mobile computing device, a personal digital assistant (PDA), a cell phone, or the like.

The user device 110 can include one or more processors and one or more computer-readable media. The computer-readable media may include computer-readable instructions executable by the one or more processors. The instructions may be embodied by one or more applications, such as application 120 shown in FIG. 1. The application(s) may generally be any application capable of facilitating management of brand-aligned product image generation. In some cases, the application(s), such as application 120, may facilitate generating brand-aligned product images in association with an entity (e.g., a company, a service, a product, an individual, etc.). In some implementations, the application(s) comprises a web application, which can run in a web browser, and could be hosted at least partially server-side (e.g., via brand-aligned product image manager 112). In addition, or instead, the application(s) can comprise a dedicated application. In some cases, the application is integrated into the operating system (e.g., as a service). As one specific example application, application 120 may be a content management tool (e.g., Adobe® Experience Manager), or a portion thereof, that enables creation, management, and delivery of content and digital assets. In some cases, such digital experiences may be provided across various channels, such as websites, mobile apps, forms, electronic communications, etc. Application 120 may be accessed via a mobile application, a web application, or the like.

User device 110 can be a client device on a client-side of operating environment 100, while brand-aligned product image manager 112 can be on a server-side of operating environment 100. Brand-aligned product image manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110 and brand-aligned product image manager 112 to remain as separate entities.

In an embodiment, the user device 110 is separate and distinct from the brand-aligned product image manager 112 and the data store 114 illustrated in FIG. 1. In another embodiment, the user device 110 is integrated with one or more illustrated components. For instance, the user device 110 may incorporate functionality described in relation to the brand-aligned product image manager 112. For clarity of explanation, embodiments are described herein in which the user device 110, the brand-aligned product image manager 112, and the data store 114 are separate, while understanding that this may not be the case in various configurations contemplated.

As described, a user device, such as user device 110, can facilitate brand-aligned product image generation. In particular, the user device 110 is generally configured to provide product data to the brand-aligned product image manager 112 and, in response, view a generated brand-aligned product image(s). A user device 110, as described herein, is generally operated by an individual or set of individuals that desire to generate a brand-aligned product image. In some cases, the user device 110 may be operated by a content creator or editor. Alternatively or additionally, the user device 110 may be operated by an individual affiliated with the brand that desires to generate a brand-aligned product image that complies with the brand guidelines.

In some cases, brand-aligned product image generation may be initiated at the user device 110. In this regard, a user may provide product data for use in generating a brand-aligned product image. Product data may refer to any data associated with a product desired to be represented in the brand-aligned product image. Product data, as used herein, may include a product representation(s) and/or a product theme indicating a theme or subject desired for an environment or background setting in association with the product representation.

For example, a user, such as a content creator or marketer, may input, provide, or select a product image. For instance, a user may input or select, via a user interface, an image including a representation of a product associated with a brand. In some cases, a user may navigate to and select a product representation and select to upload the product representation. A product representation may be any of a number of formats. Further, in embodiments, a user may input, provide, or select a product theme. For instance, a user may input or select, via a user interface, a product theme for the brand-aligned product image. A product theme may be input or selected in any of a number of ways. For example, a user may input, via text, a product theme. As another example, a user may select one or more product themes based on a list of candidate themes displayed via the user device.

An input or selection of product data can be provided via an application 120 operating on the user device 110. In this regard, the user device 110, via an application 120, might allow a user to input, select, or otherwise provide product data, such as product representations and/or product themes. The application 120 may facilitate the inputting of product data in a verbal form, a textual input form, a document form, an image form, etc. Such product data may be input at the user device 110 in any manner. For instance, upon accessing a particular application (e.g., a content management application), a user may be presented with, or navigate to, an input tool to input or select a product representation (e.g., an image file) and a corresponding product theme in which to incorporate the product representation.

In accordance with generation of a brand-aligned product image, the brand-aligned product image may be presented to the user via the application 120 operating via the user device 110. In this way, the brand-aligned product image may be displayed to an individual or entity desiring to generate the brand-aligned product. In some cases, the application 120 may enable the user to directly edit the brand-aligned product image. Alternatively or additionally, the application 120 may enable the user to indirectly edit the brand-aligned product image by enabling feedback to be provided in relation to the generated brand-aligned product image. For example, in some cases, textual feedback may be provided to initiate editing of the brand-aligned product image.

The user device 110 can communicate with the brand-aligned product image manager 112 to provide product data and/or obtain a generated brand-aligned product image. In embodiments, for example, a user may utilize the user device 110 to provide product data via the network 122. For instance, in some embodiments, the network 122 might be the Internet, and the user device 110 interacts with the brand-aligned product image manager 112 to provide product data for use in generating a brand-aligned product image(s). In other embodiments, for example, the network 122 might be an enterprise network associated with an organization. It should be apparent to those having skill in the relevant arts that any number of other implementation scenarios may be possible as well.

With continued reference to FIG. 1, the brand-aligned product image manager 112 can be implemented as server systems, program modules, virtual machines, components of a server or servers, networks, and the like. At a high level, the brand-aligned product image manager 112 manages generation of brand-aligned product images. To generate a brand-aligned product image, a reference image is generally used as a basis or source of inspiration for generating a background for a product that aligns with a brand corresponding with the product. Further, the reference image may be selected in accordance with a particular theme such that the generated brand-aligned product image is directed to a desired theme and, as such, may target a particular audience segment. In accordance with embodiments described herein, both a text-based description of a reference image and a set of image features visually describing the reference image may be used to generate the brand-aligned product image. In this way, various design aspects associated with the reference image are captured in the background generated for the brand-aligned product image. For example, the composition, scene, colors, and style of shot of the image are captured in the background of the brand-aligned product image, as well as the lighting, textures, gradients, etc. Further, in accordance with embodiments described herein, the fidelity of the product representation in the brand-aligned product image is preserved such that the product is represented in a desired manner.

In operation, in one example, a product representation (e.g., via an image) and a product theme are obtained. The product representation and/or the product theme may be selected or input by a user desiring to generate or view a brand-aligned product image. Based on the product theme, a set of candidate reference images may be identified for possible background inspirations for generating a brand-aligned product image. In one approach, a vector database containing embeddings associated with various brand-approved images may be searched to identify the set of candidate reference images that match or correspond with the desired product theme. A particular reference image may be selected, for example, from among the set of candidate reference images that match a desired product theme, for use as inspiration in generating a background for a brand-aligned product image.

In accordance with obtaining or identifying a reference image, a text description may be generated to describe the reference image. In this way, a product-environment prompt may be generated that textually describes various components of the image, such as composition, scene, colors, and/or style of shot. In some cases, to generate text descriptions associated with various image components, the reference image may be input into a large multimodal model along with an instruction to describe the image in association with one or more image components (e.g., composition, scene, colors, style of shot, etc.). The text descriptions associated with the different image components may then be combined or aggregated into a product-environment prompt for use in generating a brand-aligned product image.

To generate a brand-aligned product image, an image-augmented outpainter facilitates such image generation by performing outpainting in association with a product representation. In this regard, the image-augmented outpainter obtains the product representation and the product-environment prompt that textually describes the reference image and performs outpainting in association therewith to generate a background that is inspired by the reference image. In embodiments, in addition to using the product-environment prompt to perform outpainting in association with the product representation, image features are also used. As such, the image-augmented outpainter may extract image features from the input reference image and, thereafter, utilize the extracted image features to generate an outpainted image that includes a background environment corresponding with, or similar to, the background of the reference image. Upon generating the outpainted image, the image may be refined and/or artifacts removed to, among other things, preserve fidelity of the product representation in the outpainted image. The resulting brand-aligned product image may be presented to the user. In some embodiments, feedback may be provided (e.g., by a user) in association with the presented brand-aligned product image. Such feedback may be provided in any number of ways, for example, to reflect approval of the brand-aligned product image or disapproval of the brand-aligned product image. The feedback may be used to adjust the brand-aligned product image accordingly. In this way, various iterations of feedback may be applied to generate a brand-aligned product image that corresponds with desires and preferences of a user, while maintaining the product representation fidelity and ensuring brand consistency.

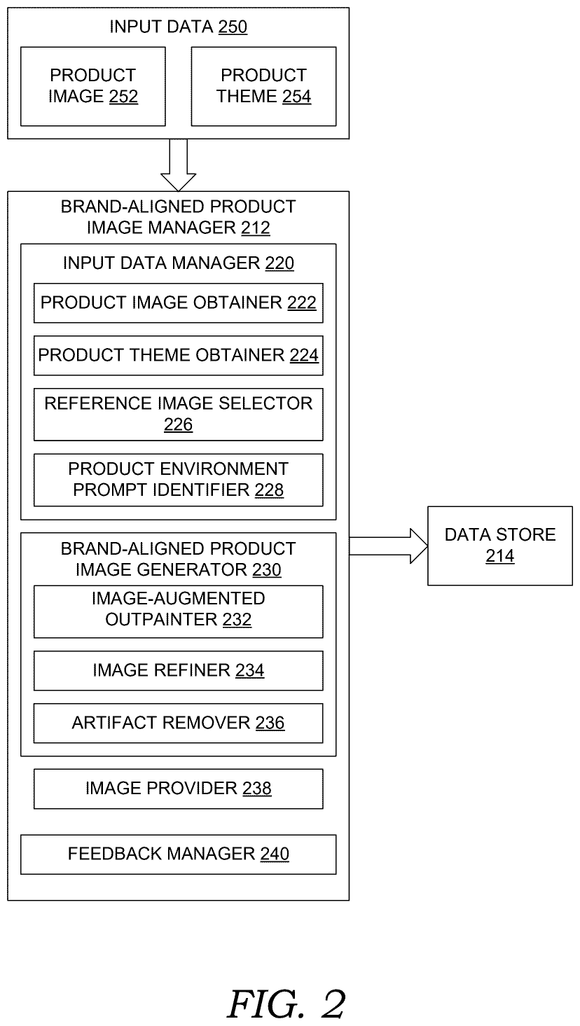

Turning now to FIG. 2, FIG. 2 illustrates an example implementation for facilitating management of brand-aligned product image generation via brand-aligned product image manager 212. The brand-aligned product image manager 212 can communicate with the data store 214. The data store 214 is configured to store various types of information accessible by the brand-aligned product image manager 212, or other server or component. In embodiments, brand-aligned product image manager 212 and user device (such as user device 110 of FIG. 1) can provide data to the data store 214 for storage, which may be retrieved or referenced by any such component. As such, the data store 214 may store product representations, product-environment prompts, candidate reference images, brand-aligned product images, image features, or combinations thereof or representations thereof.

In operation, the brand-aligned product image manager 212 is generally configured to manage generation of brand-aligned product images. In particular, the brand-aligned product image manager 212 manages outpainting associated with a product representation based on a reference image that is represented via a text description of the reference image and/or a set of image features extracted from the reference image. In embodiments, the brand-aligned product image manager 212 includes an input data manager 220, a brand-aligned product image generator 230, an image provider 238, and a feedback manager 240. According to embodiments described herein, the brand-aligned product image manager 212 can include any number of other components not illustrated. In some embodiments, one or more of the illustrated components 220, 230, 238, and 240 can be integrated into a single component or can be divided into a number of different components. Components 220, 230, 238, and 240 can be implemented on any number of machines and can be integrated, as desired, with any number of other functionalities or services.

The input data manager 220 is generally configured to manage data to be input into the brand-aligned product image generator 230. Input data for the brand-aligned product image generator 230 may include any type of data used to generate brand-aligned product images. By way of example, and as described herein, such input data includes a product image(s), a product-environment prompt(s), and/or a reference image(s).

In this way, the input data manager 220 may include a product image obtainer 222, a product theme obtainer 224, a reference image selector 226, and a product-environment prompt generator 228. According to embodiments described herein, the input data manager 220 can include any number of other components not illustrated. In some embodiments, one or more of the illustrated components 222, 224, 226, and 228 can be integrated into a single component or can be divided into a number of different components. Components 222, 224, 226, and 228 can be implemented on any number of machines and can be integrated, as desired, with any number of other functionalities or services.

The product image obtainer 222 is generally configured to obtain product images. A product image generally includes a representation of a product desired to be in a foreground of a brand-aligned product image. In some cases, a product image may be obtained via a user device. In this way, a product image may be communicated from a user device to the brand-aligned product image manager 212 via a network. For example, based on a user selection of a product image (or an indication of a product), the corresponding product image 252 of input data 250 may be communicated to the brand-aligned product image manager 212 from the user device. In other cases, a product image may be obtained via a data store, such as data store 214, or other source of data. For example, based on a user selection of a product image (or an indication of a product), the product image obtainer 220 may retrieve or access the corresponding product image from the data store 214.

A product image may be in any of a number of formats. Various examples of product image formats include Joint Photographic Experts Group (JPEG), Portable Network Graphics (PNG), Graphics Interchange Format (GIF), Bitmap (BMP), and Tagged Image File Format (TIFF), among others. In some cases, the product image may include only a representation of a product. In other cases, a product image may include in a background environment. For example, assume a product is a vehicle. In such a case, a product image may include the vehicle positioned within a background environment, such as an outdoor environment including streets, buildings, etc. In cases in which the product is included within a background environment, in some embodiments, the product image obtainer 222 may remove the background environment such that only the product remains in the image.

The product theme obtainer 224 is generally configured to obtain a product theme for generating a brand-aligned product image. A product theme generally refers to a theme desired to be incorporated into the brand-aligned product image. In this way, a product theme may be used to market a product to a particular type of audience that may have an interest in the theme. A theme may be directed to any type of subject matter or topic. For example, a product theme 254 of input data 250 may be desired to be incorporated into an image that conveys a particular holiday or season. Further, a theme may be represented or indicated in any level of granularity. For example, a theme may be specified as “outdoors” and/or “a beach scene.”

A product theme may be obtained in any of a number of ways. In one embodiment, a product theme is obtained based on input from a user, such as a user of a user device in communication with the brand-aligned product image manager 212. In this way, a user may input a particular product theme desired in association with a product or a brand-aligned product image. The product theme may be input, for example, via a text box, a user selection from a set of theme options, and/or the like. In some cases, multiple product themes may be obtained in association with a particular product (e.g., a fall theme and an outdoor environment theme).

The reference image selector 226 is generally configured to facilitate selection or identification of a reference image that corresponds with the desired product theme. A reference image generally refers to an image that is used as a reference or a basis for generating a brand-aligned product image. In this way, a reference image provides inspiration for a background or environment setting for placement or positioning of a product image in generating a brand-aligned product image. For example, assume a reference image includes a beach scene. In such a case, the beach scene is used as inspiration for a background associated with a particular product (e.g., a vehicle) in generating a corresponding brand-aligned product image.

To facilitate selection or identification of a reference image, in embodiments, a product theme is used. In this way, a set of candidate reference images may be identified based on an obtained product theme associated with a product or product image. For example, reference images that exhibit or correspond with a particular product theme (e.g., selected by a user) may be identified as candidate reference images. By way of example only, assume a user selects a “winter” theme for representing a particular product. In such a case, reference images that convey winter (e.g., ice or snow aspects) may be identified as candidate reference images that may be used for generating a brand-aligned product image(s).

Identifying candidate reference images that match or correspond with a particular product theme(s) may be performed in any of a number of ways. As one example, a semantic search may be performed to identify a set of candidate reference images that are relevant or applicable to a particular product theme. For instance, a semantic search may be performed in association with a vector database that includes vectors semantically representing various background images. In this way, a search may be performed via a vector database to identify background images that match a particular product theme(s). In some embodiments, as described herein, the background images represented in the vector database may be preapproved background images. In this regard, the background images may reflect or align with a particular brand associated with a product. For example, a brand may correspond with a set of background images that are preapproved (e.g., via a brand manager) to be used in association with the brand.

To perform a semantic search, the background images, such as preapproved background images that correspond with a brand, may be transformed into vector embeddings and stored in the vector database. For instance, a machine learning model may be used to extract and encode semantic content associated with a background image. In this way, image embeddings are generated for the corresponding images. Further, in some cases, a particular product theme(s) may be converted into a vector embedding (e.g., text embedding), for example, using a natural language processing (NLP) model to capture the semantic meaning thereof. The text embedding(s) representing the product theme(s) may then be compared to the image embeddings representing various background images (e.g., via the vector database). As one example, the text and image embeddings may be compared to identify a set of most semantically similar images via a Contrastive Language-Image Pre-training (CLIP) model, which aligns text and image embeddings in a shared vector space. To determine semantic alignment or distance, a cosine similarity between the text and image embeddings may be identified. In some cases, a background image(s) having a greatest semantic alignment may be identified as a candidate reference image(s). For instance, the background images may be ranked based on corresponding cosine similarities to a product theme, and the five most semantically aligned background images may be selected as candidate reference images. Additionally or alternatively to using vector embeddings to identify candidate reference images, other techniques or technologies may be used. For instance, keywords identified via a caption associated with an image may be identified and compared to keywords associated with a theme to identify candidate reference images.

Any number of candidate reference images may be selected. In some cases, a single candidate reference image may be selected—for example, a candidate reference image having a greatest cosine similarity in association with a product theme. In other cases, multiple candidate reference images may be selected. For instance, a set of candidate references may be selected based on a threshold number of images selected or images associated with a threshold cosine similarity.

In some embodiments, a particular reference image may be automatically selected from among the candidate reference images (e.g., for inputting to the brand-aligned product image generator 230). In other embodiments, the set of candidate reference images, or a portion thereof, may be presented for display (e.g., via a user device) such that a user may select a particular reference image to use as inspiration to generate a brand-aligned product image. In this way, in accordance with identifying a set of candidate reference images (e.g., five candidate reference images), the five candidate reference images may be presented to the user with an option for the user to select one (or more) of the background images for use in generating a brand-aligned product image.

The product-environment prompt generator 228 is generally configured to generate a product-environment prompt. A product-environment prompt generally refers to a prompt that indicates a desired environment setting or background in which placement of a product representation is desired. In some cases, a product-environment prompt generator 228 generates a prompt based on direct input from a user. For example, assume a user provides an input query or text into a text box. In such a case, the input text may be used to generate a prompt.

Alternatively or additionally, the product-environment prompt generator 228 automatically generates a product-environment prompt based on a selected reference image. For example, assume a reference image selector 226 facilitates display of a set of candidate reference images, and the user selects a particular candidate reference image as a reference image. In such a case, the product-environment prompt generator 228 may generate a prompt based on the selected reference image. In this way, the prompt may include details that accurately and adequately represent the reference image. As such, the prompt may include a text description of various image components of the reference image (e.g., contents of the image), which may be used to generate a brand-aligned product image. In embodiments, the prompt is generated to provide a text description of content capturing a background of the image (e.g., with little to no focus on a foreground object).

Image components that may be described in a product-environment prompt may include any data or attribute associated with the image. For example, image components may include composition, scene description, colors, a type of style shot, and/or the like. One example product-environment prompt may include details associated with various image components as follows:

(Composition)+(Scene Description)+(Colors)+(Style Shot).

To generate a product-environment prompt (e.g., including text descriptions of various image components associated with a reference image), the product-environment prompt generator 228 may use artificial intelligence, such as a machine learning model. For example, a large multimodal model, such as LLAVA or GPT-4V, may be used to generate a description of various image components associated with a reference image to be used as inspiration for placing a product representation. A large multimodal model generally refers to a model that can process and integrate multiple types of data (modalities) such as text, images, audio, and/or video. In this way, a large multimodal model generally understands text while also processing and comprehending other modalities, thereby enabling such models to perform tasks that require understanding and synthesis across multiple modalities. A large multimodal model has generally been trained on a large amount of data. Examples of large multimodal models include Open AI's GPT-4 Turbo with Vision and Open AI's Contrastive Language-Image Pre-training (CLIP), among others. Other technologies may additionally or alternatively be used to facilitate generation of a product-environment prompt.

Accordingly, to generate descriptions associated with one or more image components, the product-environment prompt generator 228 may generate an image-component prompt for inputting to a model, such as a large multimodal model. An image-component prompt generally refers to a prompt used to generate a description of an image component (e.g., composition, scene description, colors, etc.) associated with an image. In one embodiment, the image-component prompt may include, or indicate, the reference image to be analyzed. In addition to providing or indicating the reference image, other data may be provided, such as, for example, an instruction to generate a response related to an image component(s) associated with the reference image.

Any number of image-component prompts may be generated and used to generate descriptions of an image component(s) associated with a reference image. For example, in some cases, a single prompt may be generated and provided as input to a model. A single image-component prompt may request details or data related to any component or aspect associated with a reference image, such as a composition of the reference image, a scene of the reference image, colors of the reference image, a style of shot of the reference image, and/or the like. In other cases, multiple prompts may be generated and provided as input to a model, for example, to generate text descriptions associated with different types of image components related to a reference image. In this regard, to obtain descriptions associated with different image components for including in a product-environment prompt, each aspect or component may be identified via separate prompts into a model. Using multiple image-component prompts may result in a more accurate or detailed description of the background of the reference image.

By way of example only, various image-component prompts may be input to a large multimodal model along with a reference image, or indication thereof, and a corresponding instruction to describe a desired image component to describe in association with the reference image. For instance, the following instructions may be included in different image-component prompts to identify descriptions associated with various image components or aspects associated with the reference image:
In 500 words, give a description of the composition of the image.
In 500 words, give a description of the scene of the image.
In 500 words, give a description of colors in the image.
In 500 words, elaborate on the style of shot of this image.
In 50 words, summarize the background composition, the scene description, the colors, and the style of the shot based on the previous response by writing key features.

In this example, upon obtaining descriptions associated with various image components (e.g., composition of image, scene of image, etc.), a final instruction may request to summarize the different image component descriptions. As such, a response to the final summarization prompt may be used as, or included in, a product-environment prompt that may be used by the brand-aligned product image manager 112. As one example, a final sample response that summarizes various image components associated with a reference image may be (e.g., after writing key features in a comma-separated form using a large language model (LLM) such as GPT-4) “Dark wooden table, Christmas tree in the background adding festive touch, festive ambiance, glowing Christmas tree with golden lights, red gift box with ribbon, two pinecones, sprig of greenery with red berries, wooden backdrop, twinkling fairy lights, aesthetic, high quality, high resolution, well lit.”

In some cases, upon generating a product-environment prompt, a user may be provided with an option to modify the prompt manually or add certain elements to capture desired image components. For example, the generated product-environment prompt may be displayed to a user via a user device that enables a user to modify the prompt (e.g., add to the prompt, remove text from the prompt, etc.).

The brand-aligned product image generator 230 is generally configured to generate brand-aligned product images. In this regard, a product image that includes a product positioned in a background environment is generated that aligns with a brand associated with the product. As described herein, the background environment in which a representation of the product is placed may be generated based on inspiration from a reference image. In embodiments, such a reference image is brand-approved such that the generated background environment aligns with the brand associated with the product.

In embodiments, the brand-aligned product image generator 230 may include an outpainter 232, an image refiner 234, an artifact remover 236, and a feedback manager 238. According to embodiments described herein, the brand-aligned product image generator 230 can include any number of other components not illustrated. In some embodiments, one or more of the illustrated components 232, 234, 236, and 238 can be integrated into a single component or can be divided into a number of different components. Components 232, 234, 236, and 238 can be implemented on any number of machines and can be integrated, as desired, with any number of other functionalities or services.

The image-augmented outpainter 232 is generally configured to facilitate generation of a brand-aligned product image by extending a representation of a product to generate a background that aligns with the reference image. In embodiments, the image-augmented outpainter 232 may perform outpainting using, or based on, a product-environment prompt, such as a product-environment prompt generated via product-environment prompt generator 228. In this way, the outpainting aligns or corresponds with a description of a reference image used as a foundation for inspiration of the brand-aligned product image. For instance, the outpainting may align with text descriptions corresponding with various image components associated with a reference image. Using a product-environment prompt enables outpainting to incorporate a semantic context or narrative about what should be included (e.g., content) in the outpainting based on the reference image.

Additionally or alternatively, the image-augmented outpainter 232 may perform outpainting using, or based on, a representation of the reference image. In some cases, the representation of the reference image may be the reference image itself. In other cases, the reference image representation may be, or include, reference image features. Using image features enables outpainting to incorporate or focus on various visual elements present in the reference image, such as colors, textures, shapes, and objects in the outpainting based on the reference image.

Using a product-environment prompt (e.g., semantic context) and/or a reference image representation (e.g., visual elements) to facilitate outpainting associated with a product enables comprehensive outpainting that aligns with a reference image (e.g., brand-approved) on which to base inspiration for the outpainting. Further, using the reference image (e.g., via a product-environment prompt and/or image features) enables a brand-aligned product image to be generated in a personalized or customized manner for a particular audience.

In embodiments, the image-augmented outpainter 234 takes, as input, the product image, the environment prompt, and the reference image. To generate image features in association with a reference image, a reverse diffusion implementation may be performed. Stated differently, to extract image features of a reference image using a diffusion model, the diffusion process is generally reversed. In particular, noise may be initially introduced to the reference image to intentionally degrade the quality of the reference image. Thereafter, a diffusion model may be employed to identify and remove the noise, progressively improving the quality of the reference image. During the denoising process, the diffusion model may generate image features, for example within its attention block, which may be captured as image features associated with the reference image. In this regard, this reverse denoising process enables extracting underlying features of a reference image while the reference image is being restored. Such image features may generally include internal representations that a model, such as a diffusion model, uses to understand and reconstruct the image. Image features may include, for example, edges, textures, shapes, lighting, and/or other visual patterns.

By way of example only, noise may be added to the reference image and, thereafter, the noisy image may be input into a diffusion model to perform denoising. During the denoising process, as the diffusion model denoises the image, the model may perform multiple iterations of analysis and reconstruction. With each iteration, the attention blocks may generate and refine features that facilitate identifying the portions of the image that are noise and the portions of the image that are original content. Such image features generated by the attention blocks may be extracted at each step or iteration of the denoising process.

In some embodiments, a Features from Adversarial Robustness, Background, Intermediate, and Classifier layers (FABRIC) method may be used or integrated into the process of extracting image features during a denoising process of a diffusion model. For example, the FABRIC method may provide a structured approach to capturing and using the features generated in association with different stages of a neural network (e.g., focusing on robustness and intermediate representations). Such a method may systemically collect features from various layers of the network, including those enhanced by adversarial robustness techniques. Various layers of the network from which image features may be extracted include background layers (e.g., early layers that capture fundamental visual patterns like edges and textures), intermediate layers (e.g., middle layers where complex features and patterns are formed), and/or classifier layers (e.g., later layers that make high-level decisions based on aggregated features). Upon extracting features using the FABRIC method, such features may be aggregated to form a comprehensive representation of the reference image.

In some embodiments, the image feature generation pipeline may use the product-environment prompt. For example, a model, such as a diffusion model, may take, as input, the product-environment prompt and use image component descriptions therein to generate image features. In this way, the product-environment prompt, or a portion thereof or embedding associated therewith, may be used to guide the denoising process. For instance, during each denoising iteration, the model may use the noisy image and the product-environment prompt. Such a product-environment prompt may provide contextual information, thereby allowing the model to generate features that align with textual descriptions of the reference image. In some cases, the model's attention mechanisms may facilitate integration of the visual features extracted from the noisy image with the semantic information from the text.

Upon identifying image features associated with a reference image, the image features may be used to perform outpainting. In addition, and as described above, the product-environment prompt may also be used to perform outpainting. Using the image features and/or product-environment prompt associated with a reference image enables performance of image-augmented outpainting. In this regard, the brand-aligned product image generated aligns with a reference image that corresponds with a brand associated with the product captured in the brand-aligned product image.

Image-augmented outpainting may be performed in any of a number of ways. As one example, the image-augmented outpainter 232 may use a diffusion model to perform outpainting. In some embodiments, the diffusion model may be a same diffusion model used to generate image features, as described above. Although a diffusion model is provided as one example for performing image-augmented outpainting, other technologies may be used to perform such outpainting. For instance, generative adversarial networks (GANs), transformer-based architectures, or other AI models, among other technologies, may be used to perform outpainting.

To perform outpainting, a model, such as a diffusion model, may obtain an initial product image for which to perform outpainting. Further, in accordance with embodiments described herein, the model may obtain, as input, a product-environment prompt (e.g., providing a textual description of one or more image components associated with the reference image) and/or a reference image representation (e.g., image features extracted from the reference image, such as via a diffusion model). In this way, the product-environment prompt and the reference image representation, such as image features, may guide the extension or outpainting extending in association with the product image. Accordingly, the semantic context and image features can be appended to the outpainting pipeline, thereby enriching the representation of the reference image in a generated brand-aligned product image. In accordance with obtaining the product image, the product-environment prompt, and/or the reference image representation, a machine learning model, such as a diffusion model, may be used to generate new content that extends the product, as guided by the product-environment prompt and/or the reference image representation. In this way, the diffusion model begins to iteratively remove noise, guided by the product-environment prompt and/or extracted image features associated with the reference image. During the denoising iterations, the model may consider both the semantic meaning from text (e.g., via the product-environment prompt or a text-embedding associated therewith) and the visual features. As such, the model output provides a brand-aligned product image that aligns with the content or image components associated with the reference image as well as the visual features associated with the reference image. In implementation, the attention mechanisms within the model may dynamically prioritize important information, such as the image components and/or visual features.

In embodiments, a mask may be used in performing image-augmented outpainting. A mask facilitates isolation of areas to be generated, thereby guiding a diffusion model to focus efforts on such areas. For example, in accordance with defining an area of an image to outpaint, a binary mask may be created where the region to outpaint is marked accordingly (e.g. with 1s), and the remainder of the image is marked accordingly (e.g., with 0s or is left unmarked). Using a mask may guide the diffusion process and facilitate maintaining visual coherence.

In some cases, the image feature generation pipeline and the image-augmented outpainting pipeline may be performed in a sequential manner. For example, various iterations of the image feature generation pipeline may be performed to generate the image features, which may then be input and used by the image-outpainting pipeline. In other cases, the image feature generation pipeline and the image-outpainting pipeline may be performed in an iterative manner. In this way, an iteration of generating image features may be performed, which is then used by a corresponding iteration of performing image-augmented outpainting. As such, prior to performing an image-augmented outpainting step, the diffusion model may be used to identify image features for use in performing the image-augmented outpainting step. In appending the image features in the denoising process of the image-augmented outpainting, the model recognizes to align the brand-aligned product image with the reference image.

Although the image-augmented outpainter is generally described as a diffusion model, any type of technology may be used to perform such feature identification and/or outpainting. For example, other generative adversarial networks, variational autoencoders, transformers, or large multimodal models may be used to implement feature identification and/or outpainting. In this way, the image-augmented outpainter may include or access such technology.

As can be appreciated, the image-augmented outpainting generally focuses on the background portion, or the masked region. In some cases, however, the product image region of the brand-aligned product image being generated undergoes modifications during the outpainting process. For instance, a non-masked region may undergo adjustments in an effort to ensure seamless transitions and coherence with the newly generated content of the background portion. As such, in embodiments, an image refiner 234 may be used to refine the image, and in particular the portion of the image corresponding with the product representation. In this way, the image refiner 234 preserves or restores the details of the original product representation.

In one example, the image refiner 234 may apply techniques to perform fidelity preservation through generation (FidGen) to preserve the fidelity of the product representation or to correct image harmonization, thereby further refining the alignment of the outpainted image with the reference image. Fidelity preservation through generation includes a technique or model designed to restore or preserve the fidelity of a specific portion of the outpainted image. In this regard, such technology can maintain the original quality, details, and characteristics of a designated portion of the outpainted image, which in this case is the product image portion, while ensuring that any changes or additions to the remainder of the image blend seamlessly.

In one example implementation, the image refiner 234 may use an approach based on histogram matching, for example, in RGB space to restore the content details. In some cases, the background may be removed from the outpainted image. The product representation from the outpainted image may be resized back to the input resolution. Thereafter, cumulative histograms of both the original product representation and the edited product representation may be computed to align them (e.g., lighting conditions or other appearance properties) such that the fidelity is preserved.

The artifact remover 238 is generally configured to remove any artifacts from the outpainted image. In this regard, the artifact remover 238 may apply post-processing to remove any artifacts. The artifact remover 238 may leverage inpainting in a region around the product, which may have artifacts to remove any such artifacts. In some cases, an output product mask in association with the outpainted image may be compared with a mask of the given product image. Differences between the two masks may be determined and, thereafter, inpainting may be used in this region with a prompt (e.g., product-environment prompt). Such an approach may correct minor artifacts around the product, which may be referred to as a mask difference region.

The image provider 238 is generally configured to provide a brand-aligned product image. In some cases, the brand-aligned product image may be the generated outpainted image. In other cases, the brand-aligned product image may be the resulting image after performing image refinement and/or artifact removal in association with the generated outpainted image (e.g., via an image-augmented outpainter).

The image provider 238 may provide brand-aligned product images in any number of ways. In some cases, the image provider 238 may provide brand-aligned product images to a data store, such as data store 214. Alternatively or additionally, the image provider 238 may provide brand-aligned product images to a user device, such as user provider 110 of FIG. 1. In embodiments, the image provider 238 provides a brand-aligned product image in response to a request to generate a brand-aligned product image. For example, assume a user provides a product image and a product theme and requests generation of a brand-aligned product image in accordance therewith. In such a case, a generated brand-aligned product image may be provided to the requesting user.

Brand-aligned product images may be presented, via a user interface, in any number of ways. As one example, a brand-aligned product image may be presented in association with a product image, a product theme, a reference image, and/or the like. In this way, a user may view aspects related to the generation of the brand-aligned product image. Further, in some cases, multiple brand-aligned product images may be generated. For instance, in cases in which multiple reference images are provided, multiple brand-aligned product images may be generated in association with each reference image.

The feedback manager 240 is generally configured to manage feedback. In particular, in accordance with presenting a brand-aligned product image (e.g., to a user via a user device), a user may provide feedback related to the brand-aligned product image. In this way, the feedback manager 240 provides a training-free feedback loop that can iteratively improve the alignment of the product images with brand design guidelines and marketers' preferences by allowing the user to send feedback. As such, user feedback may facilitate a final brand-aligned product image that aligns more precisely with the brand's design guidelines and marketing preferences, among other things.

User feedback may be provided in any number of ways. As one example, a user may provide feedback by selecting a like or dislike in association with a brand-aligned product image. Other examples for providing feedback include providing a ranking, a value of a number scale, selecting an icon, and/or the like.

In accordance with obtaining user feedback (e.g., provided as input via a user device), the feedback manager 240 may provide the feedback to the brand-aligned product image generator 230, or a portion thereof, to refine the generated brand-aligned product image in accordance with the feedback. In this regard, an iterative process may occur that iteratively refines a brand-aligned product image in accordance with user feedback. In this way, a user may facilitate progressively better alignment according to the user preferences by guiding the model based on the feedback on the generated brand-aligned product images.

In some embodiments, the brand-aligned product image for which feedback is obtained and the reference image used to generate the brand-aligned product image are used in the brand-aligned product image generator 230. For example, in some cases, a mask is used for the background in the brand-aligned product image for which feedback is obtained. Thereafter, self-attention features of the background of a liked image and reference images are appended in the pipeline, for example, in a conditional pass of a stable diffusion outpainting model. On the other hand, self-attention features of a disliked image are appended in the pipeline, for example, in an unconditional pass of a stable diffusion outpainting model. In one implementation, in accordance with applying a FABRIC method, the output (e.g., image-augmented output) of the outpainter (e.g., stable diffusion outpainter) at each denoising time step is then given by: Final output=(Output of Unconditional pass)+CFG*(Output of Conditional pass−Output of Unconditional pass), where CFG is the classifier-free guidance scale. Such an approach enables attention to the background features of the liked images while avoiding disliked images, thereby enabling generation of a desired brand-aligned product image. Further, such an approach enables closer alignment with the lighting and scene composition in a background reference image, as opposed to using only text-based guidance.

### Exemplary Implementations for Facilitating Generation of Brand-Aligned Product Images

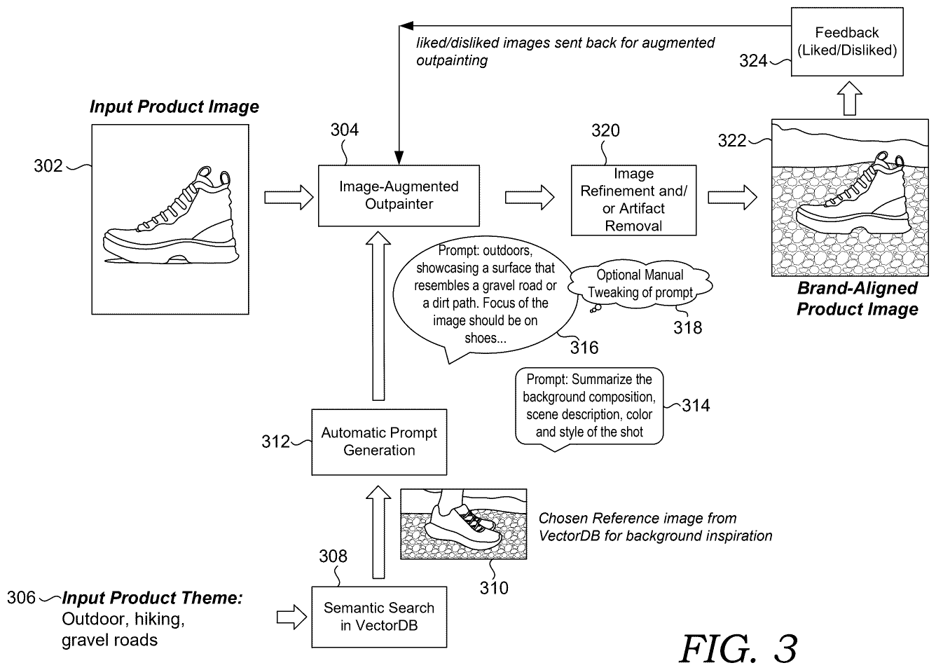

Turning to FIG. 3, FIG. 3 provides an example process flow through various aspects of the technology described herein. In this process flow, a user uploads a product image 302 via a user interface. The product image is obtained at the image-augmented outpainter 304. A user may also provide, as input, a product theme 306 (e.g., via a user interface). The product theme is used to perform a semantic search 308, for example, using a vector database that includes vectors indicating various candidate reference images. In this way, the input product theme 306 is used to identify potential reference images that may be used as inspiration for a background environment for a product representation. Assume multiple candidate reference images are identified that match the input product theme 306 and that a user selects reference image 310 to use as inspiration for a background for the product representation. In such a case, the selected reference image 310 is used to perform automatic prompt generation 312, for example using a multimodal model, to generate a product-environment prompt 316 that semantically describes the reference image 310. For example, to generate a product-environment prompt 316, an image-component prompt 314 may be generated and input to a model (e.g., a large multimodal language model) along with the reference image 310. Such an image-component prompt may request identification of descriptions of various image components, such as background composition, scene description, colors, style of shot, and/or the like. In some cases, a user may manually update or modify 318 the product-environment prompt 316.

In addition to the image-augmented outpainter 304 obtaining the product image 302, the image-augmented outpainter 304 also obtains the product-environment prompt 316 and the reference image 310. In performing the image-augmented outpainting, the image-augmented outpainter 304 may identify image features in association with the reference image 310 and augment the outpainting with the image features and the product-environment prompt 316. In this way, a background environment for the product image 302 is created that aligns with the selected reference image 310 in both semantic description and image features. For example, in addition to the background including content corresponding with the reference image 310, the background generated may also align with other image aspects, such as color, lighting, etc. Image refinement and/or artifact removal 320 may then be performed on the outpainted image generated by the image-augmented outpainter 304 to produce brand-aligned product image 322. As illustrated, the brand-aligned product image 322 includes the product representation of the shoe in the foreground of the background inspired by the reference image 310. The brand-aligned product image 322 may be presented for display to the user. Assume the user has a preference (e.g., likes or dislikes) about the generated brand-aligned product image 322 and, as such, provides feedback 324. The feedback 324 may then be provided to the image-augmented outpainter 304 to refine the image based on the feedback. The feedback may be provided in an iterative manner to progressively refine the brand-aligned product image such that a desired brand-aligned product image is ultimately generated.

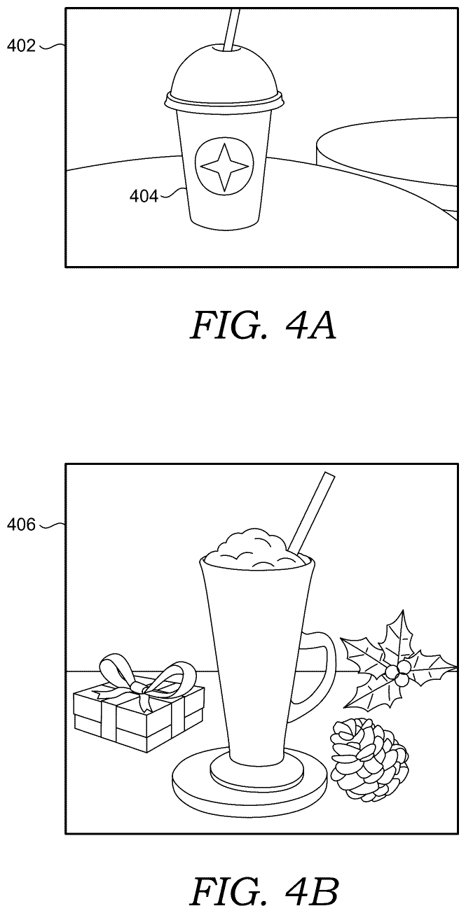

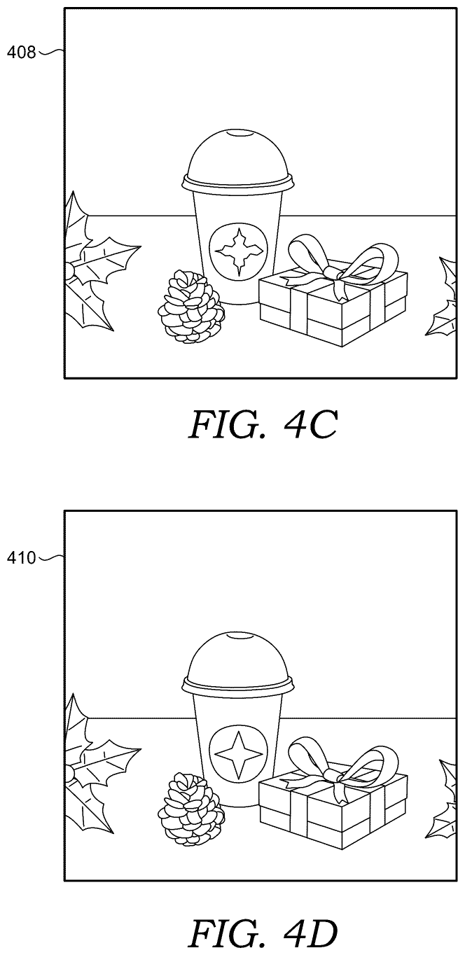

FIGS. 4A-4D provide examples of various images associated with the brand-aligned product image generation process. FIG. 4A illustrates a product image 402 that includes a representation of a product 404. Assume that the representation of the product 404 is desired to be placed in a different background context, such as a Christmas-themed setting. In such a case, a user may select a reference image 406 of FIG. 4B, as background inspiration, that has a background, composition, style, and lighting desired in a brand-aligned product image. In some cases, such a reference image 406 may be manually selected, for example, from a preapproved collection of Christmas-themed backgrounds. In other cases, such a reference image 406 may be identified via a search using CLIP-based text-image similarity in a vector database, for example, in which image embeddings of images associated with a brand kit are stored.

Thereafter, automatic prompt generation may be applied to generate a product-environment prompt that textually describes various components associated with the reference image 406 and, in particular, the background environment in the reference image 406. For example, a large multimodal model may be used to obtain or generate a text prompt describing details of the background of image 406 that includes a composition description, a scene description, a color description, and a style of shot description. For example, in this case, a product-environment prompt may describe the background as “Dark wooden table, festive ambiance, golden lights, red gift box with ribbon, one pinecone, sprig of greenery with red berries, wooden backdrop, twinkling fairy lights, aesthetic, high quality, high resolution, well lit.”

In accordance with the product-environment prompt and image features identified in association with the reference image 406, an outpainted image 408 of FIG. 4C may be generated. As illustrated, the outpainted image 408 includes the product representation in a background that is similar to the background in the reference image 406. In this example, various product details, such as the brand logo, may be distorted in the output. As such, image refinement and/or artifact removal may be performed on the outpainted image 408 to generate a brand-aligned product image 410 of FIG. 4D that may be presented to the user. In this regard, product details in the product representation may be corrected and any artifacts removed in association with the edge of the product representation. As can be appreciated, in some cases, image refinement and/or artifact removal may not be performed, and the outpainted image 408 may be provided as the brand-aligned product image. In other cases, additional or other post-processing techniques may be applied to the images.

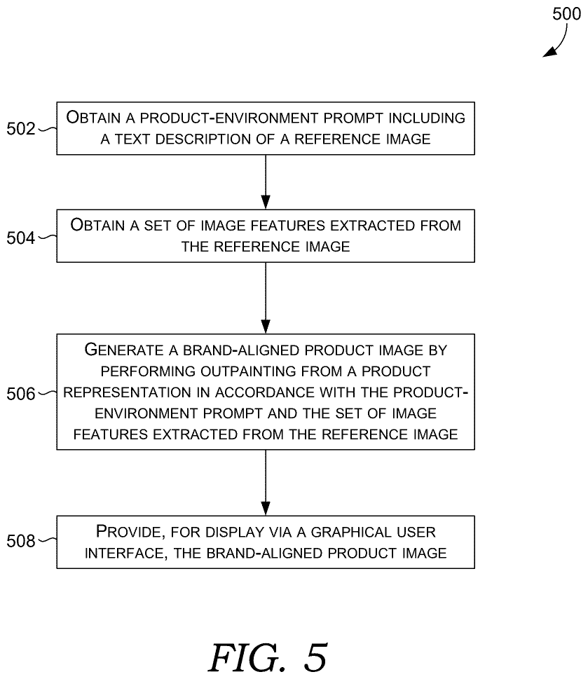

As described, various implementations can be used in accordance with embodiments described herein. FIGS. 5-7 provide methods of facilitating generation of brand-aligned product images, in accordance with embodiments described herein. The methods 500, 600, and 700 can be performed by a computer device, such as device 800 described below. The flow diagrams represented in FIGS. 5-7 are intended to be exemplary in nature and not limiting.

Turning initially to method 500 of FIG. 5, method 500 is directed to one implementation of facilitating generation of brand-aligned product images, in accordance with embodiments described herein. Initially, at block 502, a product-environment prompt including a text description of a reference image is obtained. In embodiments, the text description describes a composition associated with the reference image, a scene associated with the reference image, a color associated with the reference image, and/or a style of shot associated with the reference image. The reference image may be selected from among a set of candidate reference images identified based on a search performed using a user-selected theme. For example, based on a user-selected theme, the theme may be used to search a vector database to identify candidate reference images that match or correspond with the theme. In some cases, a product-environment prompt is generated using a set of responses generated by a large multimodal model based on input including the reference image and one or more instructions requesting descriptions of image components associated with the reference model.

At block 504, a set of image features extracted from the reference image is obtained. In one embodiment, the set of image features are extracted from the reference image using a diffusion model. Such a set of image features may represent various visual features of the reference image, such as lighting, textures, shapes, edges, etc.

At block 506, a brand-aligned product image is generated by performing outpainting from a product representation in accordance with the product-environment prompt and the set of image features extracted from the reference image. In embodiments, outpainting is performed via a diffusion model. In some cases, generating the brand-aligned product image may include applying fidelity preservation through generation in association with the product representation. Additionally or alternatively, generating the brand-aligned product image may include applying artifact removal in association with the product representation.

At block 508, the brand-aligned product image is provided for display. In some cases, an iterative feedback process may be used to refine the brand-aligned product image. For example, a user may provide feedback approving or disapproving of the brand-aligned product image and, thereafter, the brand-aligned product image may be updated based on the user feedback.

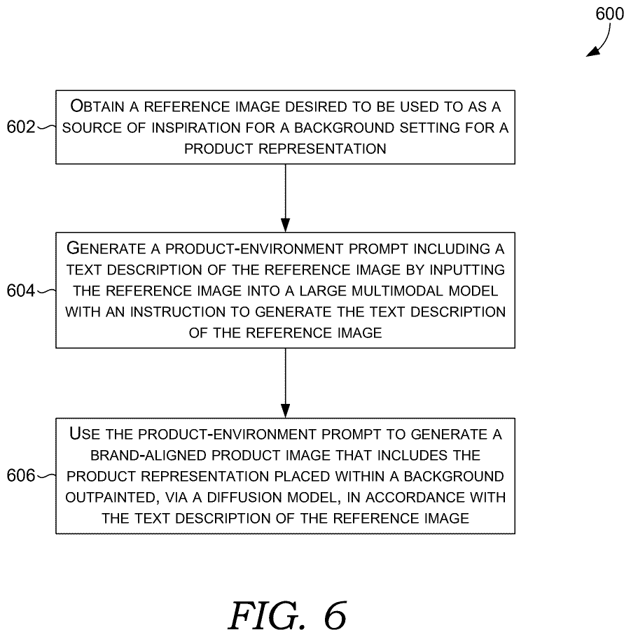

Turning to FIG. 6, method 600 of FIG. 6 is directed to another example implementation of facilitating generation of brand-aligned product images. Initially, at block 602, a reference image desired to be used as a source of inspiration for a background setting for a product representation is obtained. The reference image may be selected from among a set of candidate reference images identified as matching a desired theme for the background setting for the product representation. In embodiments, the reference image aligns with a brand associated with the product representation. In this way, basing outpainting in association with the reference image enables the outpainted image to align with the brand.

At block 604, a product-environment prompt including a text description of the reference image is generated by inputting the reference image into a large multimodal model with an instruction to generate the text description of the reference image. The text description of the reference image may describe a composition of the reference image, a scene of the reference image, a color of the reference image, a style of shot of the reference image, and/or the like.

At block 606, the product-environment prompt is used to generate a brand-aligned product image that includes the product representation placed within a background outpainted, via a diffusion model, in accordance with the text description of the reference image. In embodiments, generation of the brand-aligned product image further uses a set of image features extracted from the image via the diffusion model. In this way, the background environment is generated in accordance with image features, such as lighting, texture, and visual patterns, that may be otherwise difficult to describe using text.

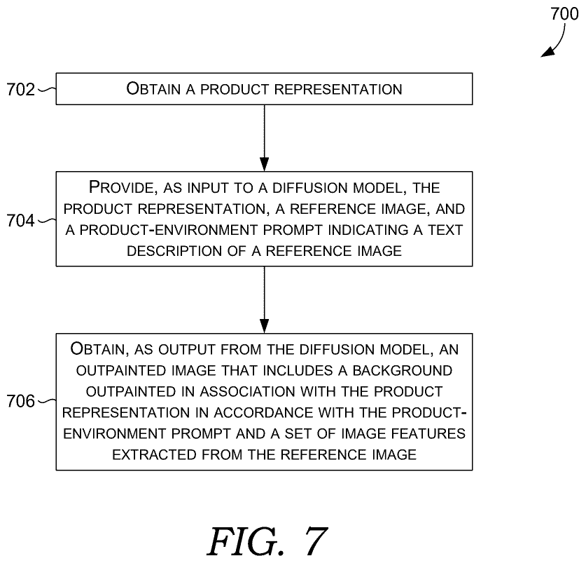

With reference now to FIG. 7, method 700 of FIG. 7 is directed to another example implementation of facilitating generation of brand-aligned product images, in accordance with embodiments described herein. At block 702, a product representation is obtained. At block 704, the product representation is provided, as input to a diffusion model, along with a reference image and a product-environment prompt indicating a text description of a reference image. At block 706, an outpainted image is obtained as output from the diffusion model. The outpainted image includes a background outpainted in association with the product representation in accordance with the product-environment prompt and a set of image features extracted from the reference image. In embodiments, fidelity preservation through generation and/or artifact removal may be applied in association with the product representation in the outpainted image. The outpainted image, or a modified version thereof (e.g., based on fidelity preservation, artifact removal, or the like), may be provided for display. In some cases, a user may provide feedback in association with the presented image and, based on the feedback, the outpainted image may be updated accordingly.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 8 in particular, an exemplary operating environment for implementing aspects of the technology described herein is shown and designated generally as computing device 800. Computing device 800 is just one example of a suitable computing environment and is not intended to suggest any limitation as to the scope of use or functionality of the technology described herein, and nor should the computing device 800 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, an illustrative power supply 822, and a radio(s) 824. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 8 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or non-volatile memory. The memory 812 may be removable, non-removable, or a combination thereof. Exemplary memory includes solid-state memory, hard drives, and optical-disc drives. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, and vibrating component. I/O port(s) 818 allow computing device 800 to be logically coupled to other devices including I/O components 820, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include radio(s) 824. The radio 824 transmits and receives radio communications. The computing device may be a wireless terminal adapted to receive communications and media over various wireless networks. Computing device 800 may communicate via wireless protocols, such as code-division multiple access (“CDMA”), global system for mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. One or more computer storage media having computer-executable instructions embodied thereon that, when executed by one or more processors, cause the one or more processors to perform a method, the method comprising:
obtaining a product-environment prompt including a text description of a reference image;
obtaining a set of image features extracted from the reference image;
generating a brand-aligned product image by performing outpainting from a product representation in accordance with the product-environment prompt and the set of image features extracted from the reference image; and
providing, for display via a graphical user interface, the brand-aligned product image.

2. The media of claim 1, wherein the text description describes a composition associated with the reference image, a scene associated with the reference image, a color associated with the reference image, a style of shot associated with the reference image, or a combination thereof.

3. The media of claim 1, wherein the reference image is selected from among a set of candidate reference images identified based on a search performed using a user-selected theme.

4. The media of claim 1, wherein the product-environment prompt is generated using a set of responses generated by a large multimodal model based on input including the reference image and one or more instructions requesting descriptions of image components associated with the reference model.

5. The media of claim 1, wherein the set of image features are extracted from the reference image using a diffusion model.

6. The media of claim 1, wherein the set of image features represent lighting, textures, shapes, edges, or a combination thereof.

7. The media of claim 1, wherein outpainting is performed using a diffusion model.

8. The media of claim 1, wherein generating the brand-aligned product image further comprises applying fidelity preservation through generation in association with the product representation.

9. The media of claim 1, wherein generating the brand-aligned product image further comprises applying artifact removal in association with the product representation.

10. The media of claim 1 further comprising:
receiving user feedback approving or disapproving of the brand-aligned product image; and
updating the brand-aligned product image based on the user feedback.

11. A computer-implemented method comprising:
obtaining a reference image desired to be used as a source of inspiration for a background setting for a product representation;
generating a product-environment prompt including a text description of the reference image by inputting the reference image into a large multimodal model with an instruction to generate the text description of the reference image; and
using the product-environment prompt to generate a brand-aligned product image that includes the product representation placed within a background outpainted, via a diffusion model, in accordance with the text description of the reference image.

12. The method of claim 11, wherein the reference image is selected from among a set of candidate reference images identified as matching a desired theme for the background setting for the product representation.

13. The method of claim 11, wherein the reference image aligns with a brand associated with the product representation.

14. The method of claim 11, wherein the text description of the reference image describes a composition of the reference image, a scene of the reference image, a color of the reference image, a style of shot of the reference image, or a combination thereof.

15. The method of claim 11, wherein generation of the brand-aligned product image further uses a set of image features extracted from the image via the diffusion model.

16. A computing system comprising:
a processor; and
one or more computer storage media storing computer-useable instructions that, when used by the one or more processors, causes the one or more processors to perform operations comprising:
obtaining a product representation;
providing, as input to a diffusion model, the product representation, a reference image, and a product-environment prompt indicating a text description of a reference image; and
obtaining, as output from the diffusion model, an outpainted image that includes a background outpainted in association with the product representation in accordance with the product-environment prompt and a set of image features extracted from the reference image.

17. The system of claim 16, further comprising applying fidelity preservation through generation in association with the product representation in the outpainted image.

18. The system of claim 16, further comprising applying artifact removal in association with the product representation in the outpainted image.

19. The system of claim 16, further comprising providing, for display, the outpainted image or a modified version thereof.

20. The system of claim 19 further comprising:
receiving user feedback associated with the displayed outpainted image or the modified version thereof; and
updating the outpainted image or the modified version thereof based on the user feedback.
